(19) United States
(12) Patent Application Publication
(10) Pub. No.: US 2013/0188936 A1
(43) Pub. Date: Jul. 25, 2013

(54) METHOD FOR CONTROLLING A HEAT PUMP WITH INTEGRATION OF A COOLANT CIRCUIT

(71) Applicant: VISTEON GLOBAL TECHNOLOGIES, INC., Van Buren Twp, MI (US)

(72) Inventors: Marc Graaf, Krefeld (DE); Tobias Haas, Koln (DE)

(73) Assignee: VISTEON GLOBAL TECHNOLOGIES, INC., Van Buren Twp., MI (US)

(21) Appl. No.: 13/745,908

(22) Filed: Jan. 21, 2013

(30) Foreign Application Priority Data
Jan. 24, 2012 (DE) 102012100554.0

(51) Int. Cl. B60H 1/00

(52) U.S. Cl. CPC B60H 1/00321
USPC 392/308; 165/104.19

(57) ABSTRACT

A method for controlling a heat pump with integration of a coolant circuit as a heat source for heating a motor vehicle at low ambient temperatures including that, in order to increase the suction pressure, the coolant temperature is raised by means of an electrical heating element in the coolant circuit such that, at the refrigerant compressor, a low pressure of greater than or equal to 1.5 bar develops.

### CROSS-REFERENCE TO RELATED APPLICATION

This application claims priority to German Patent Application Serial No. DE 10 2012 100 554.0 filed on Jan. 24, 2012, hereby incorporated herein by reference in its entirety.

### FIELD OF THE INVENTION

The invention relates to a method for controlling a heat pump with integration of a coolant circuit as a heat source for heating motor vehicles at low ambient temperatures.

### BACKGROUND OF THE INVENTION

This section provides background information related to the present disclosure which is not necessarily prior art. Vehicles equipped with modern internal combustion engines produce waste heat that can be conserved and used to heat the vehicle. A problem known in the state of the art exists that the drive systems of hybrid vehicles and electric vehicles deliver too small waste heat quantities to heat the vehicle. In this situation, it is known to provide additional heating systems that are sometimes realized in refrigeration systems, which in most cases, are operable in a heat pump mode.

In DE 10 2006 026 359 A1, for example, an HVAC is known for the combined refrigeration plant and heat pump operation in vehicles, where the total refrigerant mass flow, dependent upon the operational mode of the system, is passed through the refrigeration plant condenser or the heat pump evaporator, respectively.

In DE 198 50 829 C1 a cooling-heating circuit for a motor vehicle, particularly an electric vehicle with a fuel cell is disclosed wherein at least two devices increasing the temperature of the cooling-heating circuit and two devices lowering the temperature of the cooling heating circuit and at least one pump are provided. The devices increasing and/or lowering the temperature are at least partly assigned to the cooling-heating circuit dependent on their operational states, particularly their temperatures. To improve the use of the waste heat, a heat pump circuit can be assigned to the cooling-heating circuit.

In DE 10 2009 039 681 A1, a heating system for an electrically drivable vehicle and an operational method are known, wherein a heat storage, which can also be established as a cooling water circuit, during the charging process of the battery is charged using electrical heating. The temperature of the storage is chosen such that, for the travel time planned, the interior of the motor vehicle can be heated from the storage using a heat pump.

The prior art has various disadvantages. Switching, for example, according to DE 10 2006 026 359 A1 leads to high pressure loss in the refrigeration plant condenser. This increases the danger of icing. The output of an air heat pump reduces with falling ambient temperature as heat demand increases. At ambient temperatures lower than −10° C., a pure air heat pump can no longer provide the heat output required and other heat sources have to be integrated with the circuit to ensure that the heat demand is satisfied.

The approaches known in the art to integrate other heat sources in the heat pump operational mode, such as described in DE 10 2009 039 681 A1 are passed in parallel by refrigerant. This approach holds the danger that refrigerant is displaced in an uncontrolled manner in the parallel lines that are not actively passed.

Therefore, there is a need to improve the efficiency of the heat pump when operated at very low ambient temperatures.

### SUMMARY OF THE INVENTION

A method of improving the efficiency of a heat pump when operated at very low ambient temperatures has surprisingly been discovered.

In one embodiment, a method for controlling a heat pump for heating a passenger cabin of a motor vehicle includes the steps of providing a coolant circuit as a heat source, the coolant circuit including a coolant; integrating the coolant circuit with the heat pump; providing an electrical heating element in the coolant circuit to transfer heat to the coolant; and raising a temperature of the coolant with the electrical heating element to increase a suction pressure at a refrigerant compressor.

In another embodiment, a method for controlling a heat pump for heating a passenger compartment of a motor vehicle includes the steps of providing a coolant circuit as a heat source, the coolant circuit including a coolant; integrating the coolant circuit with the heat pump; providing an electrical heating element in the coolant circuit to transfer heat to the coolant when the ambient temperature is lower than −10° C.; raising a temperature of the coolant with the electrical heating element to a minimum temperature of −10° C. and a maximum temperature of 0° C. to increase a suction pressure at a refrigerant compressor to at least 1.5 bar and integrating the heat pump as an additional circuit of a refrigeration system of the motor vehicle.

### DETAILED DESCRIPTION OF EXEMPLARY EMBODIMENTS OF THE INVENTION

The following detailed description describes various exemplary embodiments of the invention. The description enables one skilled in the art to make and use the invention, and is not intended to limit the scope of the invention in any manner. In respect of the methods disclosed, the steps presented are exemplary in nature, and thus, the order of the steps is not necessary or critical.

Particularly, the problem is solved by a method for controlling a heat pump with integration of a coolant circuit as heat source for heating motor vehicles at low ambient temperatures such that in order to increase the suction pressure the coolant temperature is raised using an electrical heating element in the coolant circuit such that at the refrigerant compressor a low pressure of greater than or equal 1.5 bar develops. In one embodiment, the low pressure is greater than or equal 1.8 bars.

According to a further development of the invention, the method for controlling a heat pump is designed such that the coolant temperature is raised using an electrical heating element to a minimum temperature level of −10° C. for enhancing the efficiency of the heat pump and that the coolant temperature is only raised using an electrical heating element to a maximum temperature level of 0° C. with the coolant temperature only raised by a maximum of 10 K (Kelvin) above the ambient temperature using the electrical heating element.

Another advantageous embodiment of the invention is that the electrical heating element is only used at an ambient temperature of lower than −10° C. In one embodiment, a glycol-water mixture is used as the coolant. The establishment of the refrigeration system is further developed in that the heat pump can be an additional circuit of the refrigeration system of the motor vehicle when the heat pump is integrated with the refrigeration system. The control strategy according to the invention is particularly advantageously used with the refrigerants as follows: R134a, R1234yf or comparable subcritical refrigerants. In one embodiment, the suction pressure of the refrigerant compressor is raised to 1.5 bars or higher. Favorable results have been obtained using a PTC-heating element as the electrical heating element.

Thus, the concept of the invention is that, because the water temperature is controlled to a minimum temperature by using the electrical heating element, the most efficient manner of the operation of the heat pump is enabled by raising the suction pressure.

In this way, a boosting function of the heat pump for low ambient temperatures is integratable into the operational versions of the heat pump. That leads to reduced fuel consumption and, particularly, a reduced energy demand compared to a purely electrical heating because the waste heat available can additionally be used by the heat pump. Altogether, the range of electric vehicles can be increased and the capacity of the battery used better.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method for controlling a heat pump for heating a passenger cabin of a motor vehicle, the method comprising the steps of:
providing a coolant circuit as a heat source, the coolant circuit including a coolant;
integrating the coolant circuit with the heat pump;
providing an electrical heating element in the coolant circuit to transfer heat to the coolant; and
raising a temperature of the coolant with the electrical heating element to increase a suction pressure at a refrigerant compressor.

2. The method according to claim 1, wherein the suction pressure at the refrigerant compressor is at least 1.5 bars.

3. The method according to claim 1, wherein the suction pressure at the refrigerant compressor is at least 1.8 bars.

4. The method according to claim 1, wherein the temperature of the coolant is raised to a minimum of −10° C.

5. The method according to claim 1, wherein the temperature of the coolant is raised to a maximum of 0° C.

6. The method according to claim 1, wherein the temperature of the coolant is raised by a maximum of 10 K above the ambient temperature.

7. The method according to claim 1, wherein the heating element transfers heat to the coolant circuit when the ambient temperature is lower than −10° C.

8. The method according to claim 1, wherein the coolant is a glycol-water mixture.

9. The method according to claim 1, further comprising the step of integrating the heat pump as an additional circuit of a refrigeration system of the motor vehicle.

10. The method according to claim 1, further comprising the step of providing a refrigerant including one of R134a and R1234yf.

11. The method according to claim 1, wherein the electrical heating element is a PTC heating element.

12. A method for controlling a heat pump for heating a passenger compartment of a motor vehicle, the method comprising the steps of:
providing a coolant circuit as a heat source, the coolant circuit including a coolant;
integrating the coolant circuit with the heat pump;
providing an electrical heating element in the coolant circuit to transfer heat to the coolant when the ambient temperature is lower than −10° C.;
raising a temperature of the coolant with the electrical heating element to a minimum temperature of −10° C. and a maximum temperature of 0° C. to increase a suction pressure at a refrigerant compressor to at least 1.5 bar and
integrating the heat pump as an additional circuit of a refrigeration system of the motor vehicle.

13. The method according to claim 12, wherein the suction pressure at the refrigerant compressor is at least 1.8 bars.

14. The method according to claim 12, wherein the temperature of the coolant is raised by a maximum of 10 K above the ambient temperature.

15. The method according to claim 12, wherein the coolant is a glycol-water mixture.

16. The method according to claim 12, further comprising the step of providing a refrigerant including one of R134a and R1234yf.

17. The method according to claim 12, wherein the electrical heating element is a PTC heating element.
